(19) United States
(12) Patent Application Publication
(10) Pub. No.: US 2004/0153301 A1
(43) Pub. Date: Aug. 5, 2004

(54) Integrated circuit development methodology

(76) Inventors: Daniel Isaacs, Campbell, CA (US); Curtis Settles, Fort Collins, CO (US); Rafael Kedem, Sunnyvale, CA (US)

Correspondence Address: LEO PETERS, LSI LOGIC CORPORATION, M/S D-106, 1551 MCCARTHY BLVD., MILPITAS, CA, 95035, US

(21) Appl. No.: 10/356,917

(22) Filed: Feb. 3, 2003

(51) Int. Cl. G06F 17/50

(52) U.S. Cl. 703/14

(57) ABSTRACT

The present invention is directed to a development methodology for integrated circuits. Central to this methodology is elimination of the dependence of software development on actual silicon for system integration and functional validation. In a first aspect of the present invention, a method for designing an integrated circuit and software for implementation by the integrated circuit includes receiving a specification for an integrated circuit design, the integrated circuit design specification including desired integrated circuit functionality. The integrated circuit design specification is modeled by defining a behavioral model of the integrated circuit design specification modeling the desired integrated circuit functionality. The integrated circuit design specification is simulated by utilizing the behavioral model as a virtual platform. The software developed on the virtual platform may be run on a hardware based prototyping platform. This hardware prototyping system may utilize actual RTL synthesized and programmed into FPGAs enabling functional validation and interoperability system level testing of the actual integrated circuit prior to manufacture of silicon.

### CROSS REFERENCED TO RELATED APPLICATIONS

The present application incorporates co-pending patent application titled “RAPID PROTOTYPING SYSTEM” by Curtis Settles, patent application Express Mail Label Number EV 149 100 347 US, Filed Aug. 30, 2002, Attorney Docket Number LSI 02-0543, and patent application titled “INTERFACE FOR RAPID PROTOTYPING SYSTEM” by Curtis Settles, patent application Express Mail Label Number EV 149 100 355 US, filed Aug. 30, 2002, Attorney Docket Number LSI 02-0545, by reference in their entirety.

### FIELD OF THE INVENTION

The present invention generally relates to the field of integrated circuit design, and particularly to a development methodology for integrated circuits, including application specific integrated circuits, general purpose integrated circuits, system-on-a-chip (SOC), and the like.

### BACKGROUND OF THE INVENTION

Designers of integrated circuits, and especially application specific integrated circuits (ASICs) and system-on-a-chip (SOC), are confronted with increased complexity as the number of functions provided by the circuits increases. Faster speeds, greater numbers of components, increased size of the circuit, routing issues, software development, and the like, have all contributed to the increase in integrated circuit complexity. Designers are confronted with outdated methodologies that while sufficient for previous designs, may not take into account the issues experienced with the higher complexity devices.

For example, ASIC designs are typically late in design and therefore late to market. Much of this delay is caused by difficulty in integrating hardware and software and testing the design in a system environment early enough, and the need to “spin” silicon because of inadequate system tests.

Additionally, designers may be confronted with both hardware and software considerations when designing an integrated circuit. For instance, typically, simulation or verification of software was not performed in conjunction with hardware design, so the designers do not truly integrate the software with the hardware until the first silicon is achieved. Thus, it was not until tape-out and fabrication of first silicon that engineers finally addressed the actual design, but at this point the design had already been implemented in silicon. Thus, problems may be found resulting in additional iterations, such as having hardware engineers create new RTLs, create fixes for the new RTLs, and so on to a second tape-out.

Additionally, when the designers are confronted with a new chip design, the same type of problems may be encountered. For example, even if some problems have been addressed in previous designs, those same problems, as well as other problems may present themselves.

Therefore, it would be desirable to provide an improved system and method for integrated circuit design.

### SUMMARY OF THE INVENTION

Accordingly, the present invention is directed to a development methodology for integrated circuits. In a first aspect of the present invention, a method for designing an integrated circuit and software for implementation by the integrated circuit includes receiving a specification for an integrated circuit design, the integrated circuit design specification including desired integrated circuit functionality. The integrated circuit design specification is modeled by defining a behavioral model of the integrated circuit design which includes the desired integrated circuit functionality. The integrated circuit design is simulated by utilizing the behavioral model as a virtual platform. The virtual platform enables early software development allowing validation of the integrated circuit design's specification. This same software may then be run on the hardware prototype platform to confirm the specified functionality (as modeled by the virtual platform).

In a further aspect of the present invention, a method for designing an integrated circuit and software for implementation by the integrated circuit includes receiving a specification for an integrated circuit design. The integrated circuit design specification includes desired integrated circuit functionality. The integrated circuit design specification is modeled by defining a behavioral model of the integrated circuit design specification, as an executable specification which includes the desired integrated circuit functionality. The integrated circuit design specification is modeled by utilizing the behavioral model as a virtual platform. The virtual platform enables early development of the system level software which may be run and validated on the virtual platform. Running the software enables interactions and validation of the results at the behavioral level of the system (integrated circuit design) modeled by the virtual platform. This rapid prototyping system may be easily extended and configured as a reference design platform and provided to software developers to develop their own specific code to meet their individual system needs.

In another aspect of the invention, a method of the present invention provides an end-to-end solution for the development of integrated circuits, including ASIC and the like, by providing rapid prototyping of the actual integrated circuit itself. Code developed on the virtual platform may be run on actual hardware, a field programmable gate array prototype based on actual RTL, for example, emulating the ASIC and system interoperability. This may allow an end to end solution covering behavioral to functional validation prior to silicon, thus reducing development time.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1A is a block diagram illustrating a typical development schedule;

FIG. 1B is a block diagram illustrating a development schedule with modeling and rapid prototyping of the present invention;

FIG. 2 is an illustration of an exemplary embodiment of the present invention wherein a system suitable for providing rapid prototyping is shown; and

FIG. 3 is a flow diagram of an exemplary method of the present invention.

### DETAILED DESCRIPTION OF THE INVENTION

Reference will now be made in detail to the presently preferred embodiments of the invention, examples of which are illustrated in the accompanying drawings.

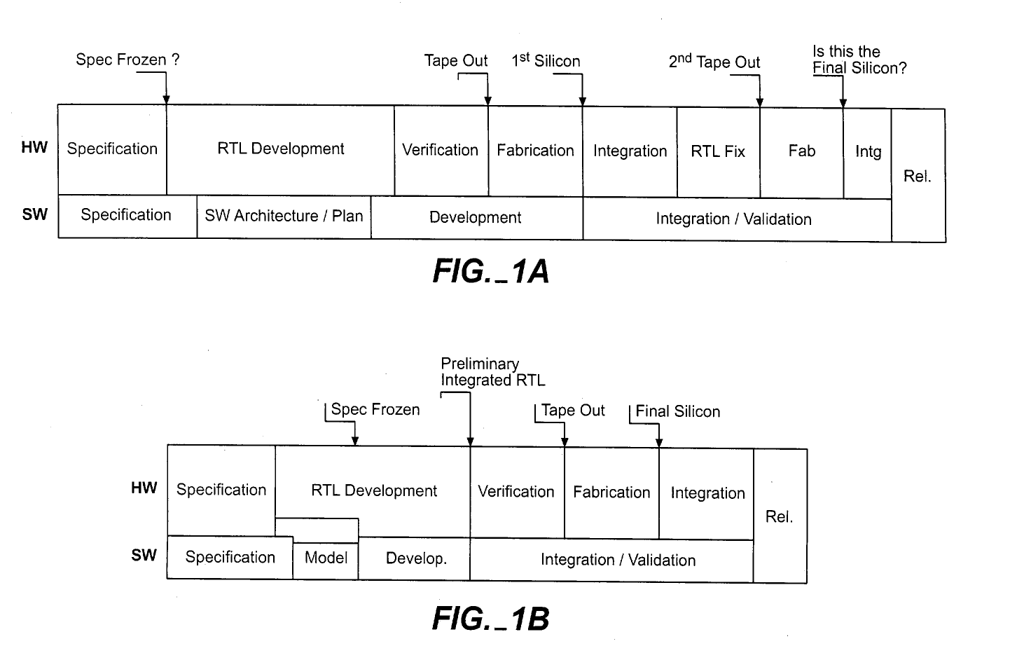

Referring generally now to FIGS. 1A through 3, exemplary embodiments of the present invention are shown. The present invention provides an end-to-end solution for the development of integrated circuits, including ASIC and the like, by providing rapid prototyping of the actual integrated circuit itself, as opposed to following the typical development schedule without rapid prototyping. Designers may be confronted with both hardware and software considerations when designing an integrated circuit. For instance, hardware engineers may create a specification, and get the specification to a point at which they want to “freeze” it. At this point, software designers start setting up a simulation environment to enable development of software to run on the integrated circuit, however, this software cannot be tested/integrated with hardware until the design is implemented in silicon.

For example, designers may start doing RTL development, and reach a point where verification of the RTL is desired. Some type of simulation or verification is typically not performed in conjunction, so that the designers do not truly integrate the software with the hardware until the first silicon is achieved. Thus, it is not until fabrication and tape-out that software engineers finally get to address the silicon. Once the hardware is finally addressed during software and system integration, problems may be found, resulting in additional iterations, such as having hardware engineers create new RTLs, create fixes for the new RTLs, and so on to a second tape-out.

Additionally, when the designers are confronted with a new chip design, the same type of problems may be encountered. For example, even if some problems have been addressed in previous designs, those same problems, as well as other problems may present themselves.

Tape-out means progressing to E-beam and creating the mask, at which point the design is fixed and locked in so that the design is ready for a production-intent chip. However, in typical design cycles, the first tape-out does not generally result in a production-ready chip and requires costly design iterations and silicon re-spins.

There are a variety of different reasons why this may not be the case: (1) the design did not meet the specification desired, such as features included did not meet the customer's requirements, so there was a problem with the original specification definition; (2) a feature was added last minute; (3) a bug was found in the hardware; and the like.

For example, when simulations are run in software, there are many instances and corner cases that cannot be fully verified until true integration, where software is validated against actual hardware. In some instances the real system is not being utilized, but rather a chip is simulated in pieces, thereby removing some of the interactions encountered in the actual running of the chip. In other instances, the simulation of a specific event or combination of events may simply be to complex to model or may take billions of cycles of simulation that are not practical given tight development time constraints. For instance, a verification suite may be utilized to verify a peripheral, but a system verification suite is typically not available. Thus, the software is tested with what is believed to be every “corner” case. However, once the peripherals are interconnected in the system, a type of interaction between hardware and software may be encountered that causes a problem. In some instances, a software work-around for the problem may be used. However, the software work-around may impact performance.

The chip, while functioning, may not function completely in the manner intended. For instance, suppose error handling functionality of a design is desired, the design may encounter a wide range of error packets. In implementation, an error packet may be encountered, which is not efficiently handled in a manner which may be accounted for by the system. Extreme “corner” cases may be encountered because it is difficult to simulate every possible combination and situation found in the actual system hardware. Thus, simulations may not take into account errors which are encountered by the system that may not be typical in normal operation. Thus, such errors may define the “corner” cases.

Therefore, in actual implementation, a system may be bombarded with a variety of inputs in a variety of situations. The simulation may not have checked to see the effect on the system with this set sequence of events occurring, which may include additional subsequent unaccounted-for events. Thus, a designer of the system may know if the system is receiving data, but may not be able to recognize the problems that will be encountered.

A designer may try to “what-if” as much as possible to address such eventualities, but there may be a case where there is intensive processing with another interface that was not previously considered at this specific time, which was not addressed. To address this problem, the present invention provides a “first time right” solution by offering early integration of the hardware with the software and offering early in-system validation prior to having an actual silicon product.

The present invention includes and provides an end-to-end solution, thereby providing a development schedule with a rapid prototyping capability. For instance, the present invention may tie in modeling of an early architectural specification, followed by additional modeling, thereby allowing a user to do early software integration with hardware before actually having a silicon product. So, before any type of silicon is provided, and before a commitment is made to a particular mask, the user may receive feedback through use of the present invention based on running software corresponding to the actual system providing early functional validation implemented through use of a prototyping system.

For example, referring now to FIG. 1, a prior design process compared to an end-to-end solution of the present invention is shown. The present invention provides modeling that overlaps the development stage, in a manner that does not prevent the continuation of development, but is performed in a way to enable up-front modeling and feedback. Thus, a designer may determine whether the hardware specification performs as expected, thereby allowing the specification to be validated early in the process.

For instance, when designing an integrated circuit, both hardware and software may be developed to provide the desired functionality. Because of this co-development, an interdependency may be created between such hardware and software development so that one process may not continue until a corresponding part of the other process is developed, such as the development of a software architecture in conjunction with register transfer level (RTL) development. For instance, previously, the development of an integrated circuit and corresponding software may go through a variety of stages, including testing, verification, integration and the like before a working product could be produced, an example of such a process is shown in FIG. 1A.

However, through use of the present invention, a rapid prototyping system and method is provided which enables the circuit to be designed in an efficient and time-saving manner with reduced revisions, which may result in a time saving of several months, as shown in FIG. 1B. For instance, the present invention may provide a modeling system which may be used in conjunction with a rapid prototyping platform to provide early software debugging and system integration and provide a customer demonstration platform prior to having first silicon.

Thus, once a user has performed the software integration, the user may be confident of the design, and then “tape-out” because the user has had the chance to model the system, both virtually as well as physically. The virtual side involves a software-modeling capability, which may then be tied into a physical system, which may include a prototyping system as described in the application which was incorporated by reference. Thus, the user may have the confidence to progress to fabrication, because a chance was had to validate the initial specification in both the behavioral aspect and the functional aspect.

The present invention provides the ability to model an integrated circuit design in both hardware and software. For instance, a designer may start off at a stage with software modeling of the entire system using a virtual graphic prototyping step using a virtual model to mode the behavioral level transactions of the system, and from that, proceed to the actual physical stage, to validate the RTL level functionality, running the same software developed at the behavioral level which may involve a FPGA prototype.

For example, using a virtual prototype through software modeling, a system model of a Comcentrix, a super I/O chip, may be provided with a preconfigured library that may support “drag and drop”, for adding and deleting functionality into a model, with software being developed from the result. Once this is achieved, the design may be prototyped on FPGA with actual hardware. This may then be taken over to a FPGA for functional validation.

Thus, in an embodiment of the present invention, early behavioral modeling may be provided, prior to functional RTL development, which is integrated into the whole flow. This will provide a user with a way of validating a specification obtained from hardware engineers with virtual prototyping to validate the behavioral level design. Thus, a software designer may arrive at desired software based on functionalities as indicated and defined in a hardware specification without having to wait for silicon.

One advantage toward behavioral modeling is that timing does not need to be addressed initially, as opposed to a RTL. Additionally, behavioral modeling, as previously described, does not need a description of the actual structure, which is time intensive to code. For instance, a behavioral model of a memory may be implemented as an array declaration. Thus, the array may be addressed in a manner similar to a memory, which is easy to model.

The present invention provides an end-to-end modeling solution, which may begin by defining a behavioral model, such as by using a C-like software simulator. The behavior model is then transferred, such as to an RTL, directly to an FPGA based hardware prototype and the like. For instance, the present invention may utilize a software simulation and proceed right into a FPGA.

Additionally, a system of the present invention may physically link the virtual side of the prototyping directly to the physical side. For example, an applique from an information handling system, such as a PC, through a PCI interface, may be physically connected to a physical FPGA-based system. The prototyping system in this manner may include a board in a computer connected to a board on a prototyping platform. Therefore a designer may model functional components that are not yet implemented, but yet the designer desires to examine the responses of the components when confronted with data.

In an embodiment of the present invention, a behavioral model of a hardware system is provided for developing and validating software for an integrated circuit. For example, a system-level simulation of the actual ASIC and any of the other board-level components that are included is provided. Thus, the present invention models the behavioral aspects of the actual system, and may be on a virtual prototyping platform. Performance of the virtual platform may be partially dependent on the PC speed, as well as the models of the CPUs that are created. Although the present discussion will address ASIC and SOC, it should be apparent that a variety of integrated circuit are contemplated by the present invention without departing from the sprit and scope thereof.

Software which is developed may be pulled over to the virtual software simulation of the hardware and run. The virtual software may support ARM tools, MIPS tools, ZSP, and the like of other processors. Further the present invention may be multiprocessor capable. The actual physical FPGA based platform, as the prototyping system described in the co-pending application, may run the exact binary code developed and validated by the virtual platform.

Thus, the present invention provides the ability to transfer a working simulation to a prospective customer without having to ship an actual board. For example, a computer readable medium may be sent, such as a CD-ROM that has a preconfigured virtual model. Preferably, the customer may write software against the model, so that a customer may trial the design. Further, in another aspect of the invention, a license is provided to enable the customer to do authoring and manipulation of the design on their own, so that the customer may create custom types of modules which may incorporate IP specific to that customer. Thus, the present invention may provide a flexible development solution.

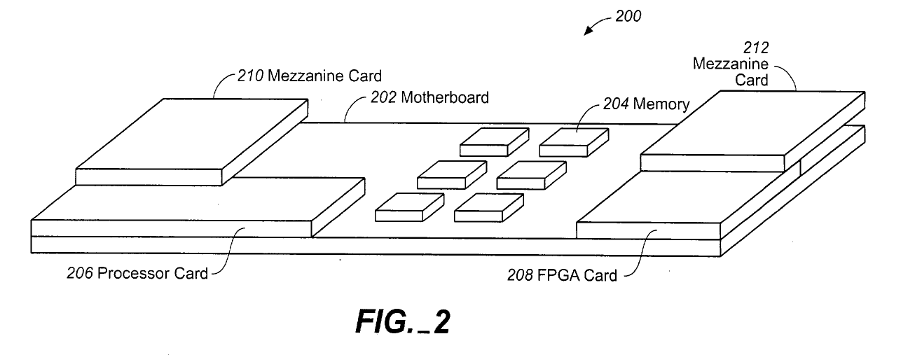

Referring now to FIG. 2, an exemplary embodiment of the present invention is shown wherein a rapid prototyping system is configured as an ASIC-ON-A-BOARD for use in an end-to-end solution for the development of integrated circuits, including ASIC and the like. A motherboard is shown having four daughter card slots. The hardware system is compliant with the rapid prototyping system described in accordance with the application which was incorporated by reference in its entirety.

A rapid prototyping system 200 may include a central motherboard 202 with common memory 204. Daughter cards, such as processor cards 206, FPGA cards 208, and the like may be connected to the motherboard 202. For example, the daughter cards may be connected through an advanced microcontroller bus architecture (AMBA) advanced high-performance bus (AHB) to the motherboard to provide specific desired functionality. Additionally, the daughter cards may be stackable enabling multiple daughter cards to reside in the same slot. Mezzanine cards 210 & 212 may plug into the daughter cards for physical I/O connectivity, i.e. physical interfaces, for the system. The daughter cards may utilize similar connections as utilized by the daughter card to the motherboard, and the like without departing from the spirit and scope of the present invention. Preferably, the specifications are standardized to enable a user to design and interchange components of the system, thereby providing a modular development system.

In this way, a standardized AMBA based rapid prototyping vehicle may be provided. The system may be a configurable FPGA-based system which is extendable to support multiple cores and interfaces. Preferably, the system is processor independent and is thus suitable for supporting multi-instruction processing system (MIPS), advanced RISC machine (ARM), ZSP, and the like. The system may also support a common mechanical and electrical form factor and specification so that all components/boards of the system are customizable and easily extended to meet application specific needs and extensions, which may be designed in an efficient and intuitive manner by a circuit designer. Thus, the system may enable the ready and efficient prototyping of integrated circuits, and even the wide range of functionality desired in application specific integrated circuits.

The present invention enables rapid prototyping and reductions in development and integration time. For instance, a rapid prototyping system may provide an early hardware debugging and software development platform. Additionally, as previously mentioned the present invention provides a custom CPU option due to processor independence and enables multi-processor system prototyping and debugging. Thus, the rapid prototyping system may be configured to add customer logic and application specific functions. Further, the rapid prototyping system demonstrates FPGA prototyping methodology flow for ASIC IP.

By utilizing the present invention, the hardware model as described may be implemented virtually. In other words, a virtual system may provide the same functionality as provided by the hardware, except it is modeled as a virtual system in a behavioral manner. Therefore, when the system is “modeled,” the behavior of the system's transactions and functionality is modeled. A variety of components may be modeled, such as AMBA reference design included in a motherboard, processors, MIPS processors, and the like as contemplated by a person of ordinary skill in the art.

Thus, through use of the virtual ASIC-ON-A-BOARD, an actual hardware system is not needed initially, but may still be desirable as described subsequently. Further, the virtual model may be sold separately. For example, a customer may desire an ASIC, which has three processors, an ARM, a MIPS, a ZSP, an Ethernet control, and USB. A system may be pre-configured based on the IP that is provided through the virtual system. The pre-configured system may be placed on a removable data storage medium, such as a CD ROM, and given to the customer to try. Preferably, the pre-configured system may enable software to be developed against it. Then, an actual hardware platform may be provided for prototyping, such as an actual ASIC-ON-A-BOARD.

For instance, a customer may desire a SOC for a voiceover IP application and wonder about which processors are needed to perform the specific functions and obtain the desired features. A variety of concerns may be encountered, such as whether more than one processor is needed, the type of processor, bottlenecks through each option, where the problems will occur with each option, what are the functional components needed, and the like.

In an exemplary embodiment of the invention, an ASIC may include three ARM processors. In the virtual implementation, models of the three ARM processors with an Ethernet controller demonstrate the capability in a behavioral manner.

The present invention enables a hierarchical definition of each element. For instance, the Ethernet controller may include a decoder block, a controller block, as well as the byte, and may have a virtual FIFO.

The virtual platform may be provided in a structured and graphical interface that translates to C-like code. The components and interactions may be built in sequence, such as in a flow to create an executable specification.

In an aspect of the present solution, the software may be developed and run on the virtual platform as well as on a development platform. The exact same code that is run on the virtual platform may be run on the hardware platform for validation of software.

The virtual platform may be provided as a starting point, as a pre-configured set system. For example, a customer may take an application's specific feature and model the application using “drag-and-drop” from a preconfigured library of IP, to create and model their own IP to fix their own configuration. For instance, a manufacturer may provide a virtual platform on a CD-ROM to a customer that details a contemplated system. The virtual platform may be examined by the customer to determine if the system meets the desired requirements. Thus, the virtual platform may provide modeling, a review of the hardware specification, and early software development through this design “kit.”

This kit may be a starting kit for selling the actual hardware to the customer. An advantage of the virtual platform is that the customer may utilize multiple copies of the platform in a very time efficient manner. For instance, a customer may have 200 software developers, but did not want to purchase 200 ASIC-ON-A-BOARD systems, which may take time to fabricate and design. Instead, a software model is provided, such as 200 CD ROMs, that each of the engineers may test and interact with the model to determine if the model meets the desired specification.

Preferably, as described earlier, the model is behavioral, so the model does not need to be run at any particular frequency. Therefore, the software engineer may determine that the results and interactions are sufficient for the contemplated implementation.

At this stage of the development process, the customer does not have to worry about the actual ASIC. Rather, the customers may examine and address the broad aspects of the product for a particular need such as general components and interactions of the components. For example, a customer may specify a system with three ARM processors, has USB, I²-C, a high-speed peripheral interface, and memory control. The provider of the present invention may then model the system behaviorally and supply a removable medium having the model to the customer. The customer may then test the model for their particular needs. Thus, a design may be made “right” before an actual silicon product is produced.

Additionally, a customer may have proprietary systems of their own which may need to be incorporated. Through use of the present invention, a model of the system may be made and incorporated into the actual virtual system and have code written against it as previously described. Thus, the customer is still able to determine if the product would function as desired even if the customer has unique and/or proprietary systems. Further, through use of behavioral modeling, a customer may be able to preserve their IP.

The present invention may provides a collection of cores that are locked and preconfigured which work as a “black box” so that neither the customer nor the manufacturer need to address the actual workings of the components, but rather may concentrate on the overall functionality and interconnections.

A system of the present invention may be provided with a library of pre-configured components which are behaviorally modeled to test interactions and results in an early stage of design of an ASIC. Further, licensing may be arranged at one time and tracked through creation of the virtual platforms, so that the manufacturer or the customer does not need to address those issues each time, separately.

The present invention is not specific to an ASIC-ON-THE-BOARD. Other platforms may be modeled and employed without departing from the spirit and scope of the present invention. Thus, a variety of integrated circuits and solutions are contemplated by the present invention as understood by a person of ordinary skill in the art.

The virtual platform is the first step in the end-to-end solution in an embodiment of the present invention. A system is provided which may incorporate manufacturer and customer IP to enable software development to be performed at an earlier stage in the process through a pre-configured platform.

A program of instructions of the present invention providing a virtual platform may include an integrated time limit to enable the customer to interact with the platform over a specified amount of time.

The virtual platform may take a variety of configurations without departing from the spirit and scope of the present invention. For instance, in a first example, the virtual platform may include a drag-and-drop capability, which allows a customer to author a specification, and may be provided as a development “kit.” Thus, a customer may be provided with the capability of a full component library available for drag-and-drop, authoring capabilities, so that the customer may create modules for application-specific requirements, and the customer may get a platform development to get licensed, with the licensing passed through the manufacturer.

In a further example, the virtual platform is provided in a fixed configuration for verification and testing, but does not include authoring capabilities, for a low-cost entry solution for a customer.

In this way, a customer may have access to thousands of ASIC-ON-THE-BOARD virtual platforms through the ability to “pick and choose” the components. The components may be targeted by the manufacturer based on the customer's needs, such as specific components for specific purposes.

For example, a pre-configured platform may be limited to three processors with an Ethernet. Such a platform may enable a customer to test for functionality and correspondence with specified needs. When utilizing the platform development kit, an authoring ability may be provided, along with the ability to choose functional components.

A manufacturer, even in a development kit, may wish to limit the options to products supplied by the manufacturer to realize the benefits of providing such a system. However, it may still be desirable to provide the ability to add custom components to manufacturer specified components to enable further customization of the product, so that the customer may use the virtual platform to create their own virtual platforms.

A removable medium in accordance with the present invention may be configured in a variety of ways. The medium may include applications, executables, software device drivers, behavioral models, and the like on the medium. Preferably, the same software which would be utilized on the finished product would be executable through use of the virtual platform. Thus, the risk of producing the product is greatly reduced.

Additionally, the customer may write custom software, and change the software as desired. Thus, the customer does not have to wait for evaluation boards or emulation boards to be designed and developed. In this way, there is no “bottlenecking” from the hardware side to the software side. For example, hardware systems as previously employed may break, thereby delaying both the hardware side and the software side of the development process. Through use of the present invention, the virtual platform may provide a behavioral model to a designer to enable software development to continue even in the event of chip failure and the like on the hardware side.

Further, the specification is validated at an earlier stage of the process than was previously possible. Thus, a design, arrived at from a hardware engineer, may be modeled so that software may be written to provide the desired functionality. Further, the software may test the operability of the hardware specification to work as a cross-check to the development process. For instance, a software developer may take a specification which contemplates a certain result, but in implementation as modeled does not perform as such when confronted with software.

This virtual ASIC-ON-A-BOARD extends all the way to product completion because the customer may take the design and test it against a contemplated use. Thus, the customer may be provided with a virtual platform which frees up the ASIC “front end” of the development process, because the customer may, on their own, arrive at the basic product requirements, preferably clearly defining the requirements.

Although some previous prototyping solutions were attempted, none rose to the level of a complete solution. For instance, modeling as disclosed by the present invention was not employed at such an early stage in the process, there was no support for third party solutions, were not based upon the AMBA architecture, did not support shared memory, and the like. Thus, the present invention provides a flexible solution.

In an embodiment of the present invention, the ASIC-ON-THE-BOARD is an AMBA bay system with FPGA configurability with independent busses. The board supports MIPS, ARM, ZSP and future processors in an open architecture. For example, a customer may take the specification for a mezzanine card, daughter-card or even the motherboard and create a customized board.

The ASIC-ON-THE-BOARD concept has three key components: (1) a central motherboard, (2) shared memory; and (3) plug-in daughtercards. These are both processor- and FPGA-based, which provides the system with a variety of “personalities.” For instance, three ARM processors may be utilized with an FPGA daughtercard, an ARM, MIPS, ZSP and an FPGA daughtercard may be used, and the like. The mezzanine cards may plug right on top of the daughter-cards to provide the actual physical interface, such as to physically connect an Ethernet or a phone line. Thus, the daughter-cards provide the processors while the mezzanine cards provide input/output.

The architecture may include a shared memory architecture, such as a FPGA that has a multi-ported memory controller. Each one of the slots may have high-speed access into the memory, and may execute simultaneously.

AMBA includes both AHB, which is the ARM high-speed bus, and the APB, which is an advanced peripheral bus. The AHB bus may be a high-speed bus, while the APB bus is the peripheral bus, which is typically slower because the peripherals do not need the same amount of speed. It should be noted that in an embodiment, a motherboard with FPGAs may have the AMBA reference design that we have implemented into FPGAs and run.

The platform may include a whole verification environment. For example a platform may boot and run an OS, may have all the software drivers necessary to run the system, and may be easily modifiable. Additionally, the platform design may enable plug and play of different processors, so that a designer may develop a dual MIPS, an ARM ZSP, and the like.

An advantage provided by the present invention is that both the “actual” platform and the virtual platform may run the same software. Additionally, the platform may be utilized as a reference design for the design and testing of an integrated circuit. For example, an ASIC-ON-THE-BOARD running may include three processors, with the Ethernet controller, implemented through the use of daughtercards. The Ethernet controller is implemented through the use of a FPGA. Each of the daughtercards may arbitrate to get access to a common bus of the architecture. The daughter cards only have to arbitrate for the common bus, because the common memory is implemented as a multi-port memory that does not need arbitration. Therefore, all four daughtercards could access the memory simultaneously.

A customer may desire an integrated circuit having additional features, such as a home gateway solution. Therefore, application specific features may need to be added to support the home gateway. For instance, an ARM subsystem may be included as an ARM daughter-card, a ZSP subsystem here as a ZSP daughtercard, which was our ZSP daughter-card, and a mezzanine card for the telephony application.

The subsystems may be self-contained so that arbitration over the bus is not needed, and therefore performance is increased, such as processor subsystem running at processor speed. For instance, a processor and an FPGA may be included in a daughtercard so that a customer may utilize custom logic and run the logic at the high-performance speeds of the daughtercard in interaction with the processor. The logic may step down in speed, and arbitrate down to the motherboard. A series of daughtercards may be provided with or without FPGA, through the AMBA bus to the motherboard to the shared memory.

The platform may act as a reference design for a SOC that includes multiple processors, a multi-ported memory controller, a multi-port communication module to allow processor intercommunication, and the like. The reference design may then be supplemented with the desired functionality, such as a verification environment, ability to boot an OS, have all the software drivers for all the peripherals, and the like.

Therefore, the present invention may act as an end-to-end solution for the development of an integrated circuit. The combination of modeling and going into an actual RTL to FPGA prototyping prior to having silicon or being engaged in the ASIC, helps to verify and make the process more efficient. This may give developers the confidence that when progressing to silicon, the software was actually integrated with the hardware. Thus, most of the problems have been addressed.

The behavioral modeling and software developed may then be ready for validation at the functional FPGA level through preliminary integrated RTL, such as the actual Verilog RTL that the hardware developers had written, based on the initial executable specification of modeling from the software engineers.

At this point in the development process, the product may be prototyped. For instance, the RTL may be re-targeted to a FPGA, which may prototype and verify the function in the FPGA prototyping system, such as though use of the corner cases and timing closure previously discussed (cycle accuracy). For instance, a design may not get cycle-by-cycle accuracy based on the processor at a behavioral level without extensive time spent developing the model. By implementing the RTL in FPGA as actual hardware with the ASIC-ON-A-BOARD, the user may get cycle-by-cycle timing closure at a functional level, as well as cycle-by-cycle verification independent of an ASIC itself or the ASIC process.

Although this discussion has presented the process in what may be considered an “ideal world” it should be apparent to a person of ordinary skill in the art that although there may be some minor modification of the design, the result substantially corresponds to the design that would be incorporated into an actual circuit. For instance, at the preliminary integrated RTL level, a modeling capability is provided which may be verified on the FPGA which results is a structure ready for “tape out.” Once prototyped into an FPGA, from the RTL with FPGA-specific technology, a net list is obtained that would substantially represent the same netlist that could be taken into an ASIC. Although it may not be exactly one-to-one correspondence, the design through use of the present invention substantially corresponds to the desired result.

However, it is anticipated that with newer FPGA technologies, such as the ability to handle such components as gated clocks, a designer will be able to take the ASIC RTL, convert it to an FPGA and use that same over in the ASIC itself.

This may also work as a test for the RTL, since it may be run through different synthesizers and therefore identify problems that may not be determined when only run through simulation.

At this point, a designer may have a preliminary RTL, and desire to run software on a corresponding hardware system to assess the functional behavior of the system. The designer may take the RTL and target it towards FPGA technology, such as by synthesizing it to create a FPGA net list. This may be implemented by a FPGA to provide actual physical hardware which may run and functionally verify that the RTL performs as expected. Thus, the designer may identify mistakes, corner cases, and the like. The designer is in the FPGA domain, but uses an RTL which the designer already created, which may be re-synthesized towards an ASIC process. Through use of the present invention, what is synthesized and tested on the FPGA substantially corresponds to what is synthesized with the ASIC.

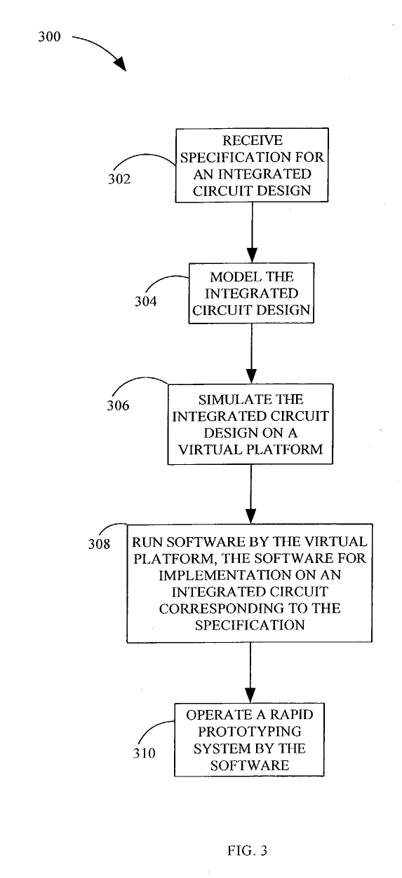

For example, referring now to FIG. 3, an exemplary method 300 of the present invention is shown. Method 300 may depict the steps of an end-to-end solution for the design and development of integrated circuits and software for implementation by the integrated circuit. Method 300 may begin upon when a specification for an integrated circuit is received 302. The integrated circuit specification may include desired integrated circuit functionality, such as functional components, functional results, operability, and the like. The integrated circuit design specification is modeled 304, which includes defining a behavioral model of the integrated circuit design specification which includes the desired integrated circuit functionality.

The integrated circuit design specification is simulated by utilizing the behavioral model as a virtual platform 306. The virtual platform allows software to be run which may also be run by an integrated circuit having the desired integrated circuit functionality. The software for implementation is then run by the virtual platform 308, which enables interactions and results of the virtual platform to be tested with the software. The software is also operated on a rapid prototyping system configured as a reference design platform 310.

Thus, functionally, the designs are equivalent, and the only resolution that needs to be addressed in the ASIC world or the FPGA world is timing. However, because of the cycle-by-cycle accuracy achieved through the FPGA and verification, such a process may be readily addressed by the designer. Thus, the present invention provides system-level verification, the software and the hardware together in the real world to enable a “first time right” solution.

Previously, the hardest problems to address in the design of an integrated circuit were in the system domain, because of the sheer number of vectors which needed to be run. Through use of the present invention, an environment is provided so that a software engineer may obtain functional validation without the massive outlay of resources in generating a mask that previously was not known that it would even work. Thus, functionally the system may be determined whether to work or not before actual implementation in silicon, thereby greatly conserving resources in both time and money.

In this way, the present invention may integrate software with hardware before a silicon product is actually produced, thereby greatly reducing the time to produce, since corrected silicon products do not need to be produced, as shown in FIG. 1. Through investigation of the present invention, it was found that a time saving of a minimum of four months in the design process was achieved. Thus, the present invention fulfills a long-felt need in the industry and commercial success is expected.

The present invention may take the hardware platform as previously described and provide it as a virtual platform for interaction with a software designer. Preferably, all the functionality of the hardware platform is provided, such as four daughter-card slots, a common memory, and the like. Additionally, the output of the virtual model is identical to the output that would be achieved through use of the actual hardware model. In this way, the virtual model and the hardware model may serve as a cross check to validate the correctness of the system. Because of this, a true software model of the physical system is provided which may run the same software, thereby enabling a software designer to create and test software at a much earlier stage of the development process.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention may be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for designing an integrated circuit and software for implementation by the integrated circuit, comprising:
receiving a specification for an integrated circuit design, the integrated circuit design specification including desired integrated circuit functionality;
modeling the integrated circuit design specification, wherein modeling includes defining a behavioral model of the integrated circuit design specification which includes the desired integrated circuit functionality; and
simulating the integrated circuit design specification by utilizing the behavioral model as a virtual platform, wherein the virtual platform allows software to run by the virtual platform which may also be run by an integrated circuit having the desired integrated circuit functionality.

2. The method as described in claim 1, further comprising running software for implementation on an integrated circuit having the desired integrated circuit functionality and specification by the virtual platform.

3. The method as described in claim 2, further comprising operating a prototyping system configured as a reference design platform by the software which was run on the virtual platform.

4. The method as described in claim 3, wherein the running and operating are performed before an integrated circuit having corresponding to the specification is manufactured.

5. The method as described in claim 4, wherein running the software run by the virtual platform enables interactions and results of the virtual platform with the software to be tested.

6. The method as described in claim 1, wherein the simulation enhances software development by providing validation of the specification.

7. A method for designing an integrated circuit and software for implementation by the integrated circuit, comprising:
receiving a specification for an integrated circuit design, the integrated circuit design specification including desired integrated circuit functionality;
modeling the integrated circuit design specification, wherein modeling includes defining a behavioral model of the integrated circuit design specification which includes the desired integrated circuit functionality;
simulating the integrated circuit design specification by utilizing the behavioral model as a virtual platform, wherein the virtual platform allows software to run by the virtual platform which may also be run by an integrated circuit having the desired integrated circuit functionality;
running software for implementation on an integrated circuit having the desired integrated circuit functionality and specification by the virtual platform, wherein running the software enables interactions and results of the virtual platform with the software to be tested; and
operating a prototyping system configured as a reference design platform by the software which was run on the virtual platform.

8. The method as described in claim 7, wherein the virtual platform includes a behavioral model of a rapid prototyping system.

9. The method as described in claim 7, wherein the running and operating are performed before an integrated circuit having corresponding to the specification is manufactured.

10. The method as described in claim 7, wherein the simulation enhances software development by providing validation of the specification.

11. A system for designing an integrated circuit and software for implementation by the integrated circuit, comprising:
a memory suitable for storing a program of instructions; and
a processor suitable for performing the program of instructions, the processor communicatively coupled to the memory, wherein the program of instruction configures the processor to
receive a specification for an integrated circuit design, the integrated circuit design specification including desired integrated circuit functionality;
model the integrated circuit design specification by defining a behavioral model of the integrated circuit design specification which includes the desired integrated circuit functionality; and
simulate the integrated circuit design specification by utilizing the behavioral model as a virtual platform, wherein the virtual platform allows software to run by the virtual platform which may also be run by an integrated circuit having the desired integrated circuit functionality.

12. The method as described in claim 11, wherein the virtual platform includes a behavioral model of a rapid prototyping system as a reference design platform.

13. The method as described in claim 11, further comprising running software for implementation on an integrated circuit having the desired integrated circuit functionality and specification by the virtual platform.

14. The method as described in claim 11, further comprising operating a rapid prototyping system configured as a reference design platform by the software which was run on the virtual platform, wherein running and operating are performed before an integrated circuit having corresponding to the specification is manufactured.

15. The method as described in claim 11, wherein running the software run by the virtual platform enables interactions and results of the virtual platform with the software to be tested.

16. A method for designing an integrated circuit and software for implementation by the integrated circuit, comprising:
modeling an integrated circuit design specification of a integrated circuit by defining a behavioral model of the integrated circuit design specification which includes the desired integrated circuit functionality;
developing a set of instructions run on a virtual platform based on the behavioral model;
integrating said set of instructions with a hardware prototyping system platform developed utilizing register transfer level development, wherein the hardware prototyping system platform operates similar in functionality with said integrated circuit design specification.

17. The method as described in claim 16, wherein said set of instructions is run on the hardware prototyping system platform allowing true system-level interoperability validation.

18 The method as described in claim 16, wherein running of said set of instructions run on the virtual platform provides validation of functional correctness and proper operation of the integrated circuit design specification prior to manufacture of the integrated circuit.

19. The method as claimed in claim 16, wherein fabrication of a chip may be performed after validation removing the dependence of software development on fabrication of the chip for system integration and functional validation.
